(19) United States
(12) Patent Application Publication
(10) Pub. No.: US 2009/0048097 A1
(43) Pub. Date: Feb. 19, 2009

(54) PROCESS FOR THE PREPARATION OF AN OXIDIC CATALYST COMPOSITION COMPRISING A DIVALENT AND A TRIVALENT METAL

(75) Inventors: William Jones, Cambridge (GB); Dennis Stamires, Dana Point, CA (US); Paul O'Connor, Hoevelaken (NL); Michael Brady, Studio City, CA (US)

Correspondence Address: Albemarle Netherlands B.V.;Patent and Trademark Department, 451 Florida Street, Baton Rouge, LA, 70801, US

(73) Assignee: AKZO NOBEL N.V., BM Amhem (NL)

(21) Appl. No.: 10/582,601

(22) PCT Filed: Dec. 6, 2004
(86) PCT No.: PCT/EP2004/013913

§ 371 Date: Nov. 3, 2008

Related U.S. Application Data
(60) Provisional application No. 60/527,756, filed on Dec. 9, 2003.

(30) Foreign Application Priority Data
Jan. 9, 2004 (EP) 04075063.0

(51) Int. Cl. B01J 27/232; B01J 27/14; B01J 23/00; B01J 27/24; B01J 23/34; B01J 23/745; B01J 23/75; B01J 23/72; B01J 23/06; B01J 23/02; B01J 21/02; B01J 23/26; B01J 23/22; B01J 23/28; B01J 23/30; B01J 23/10

(52) U.S. Cl. 502/174; 502/208; 502/302; 502/300; 502/200; 502/324; 502/337; 502/338; 502/325; 502/343; 502/345; 502/340; 502/213; 502/355; 502/319; 502/321; 502/303; 502/304; 502/353; 502/305

(57) ABSTRACT

Process for the preparation of an oxidic catalyst composition consisting of one or more trivalent metals preferably aluminum, one or more divalent metals preferably magnesium and more than 18 wt % of one or more compounds selected from the group consisting of rare earth metal compounds, phosphorus compounds, and transition metal compounds, which process comprises the steps of preparing a precursor mixture consisting of (i) or more trivalent metal compounds, (ii) one or more divalent metal compounds, (iii) one or more compounds selected from the group consisting of rare earth metal compounds, and transition metal compounds, and (iv) optionally water, which precursor mixture is not a solution. The resulting oxidic catalyst composition is suitable as a metal trap and SOx sorbent FCC processes.

The present invention relates to a process for the preparation of an oxidic catalyst composition comprising a divalent and a trivalent metal, an oxidic catalyst composition obtainable by this process, and the use of this oxidic catalyst composition in fluid catalytic cracking (FCC) processes as catalyst or adsorbent.

EP-A 0 554 968 (W.R. Grace and Co.) relates to a composition comprising a coprecipitated ternary oxide comprising 30-50 wt % MgO, 5-30 wt % La₂O₃, and 30-50 wt % Al₂O₃. The composition is used in FCC processes for the passivation of metals (V, Ni) and the control of SOₓ emissions.

This document discloses two methods for preparing such a composition. In the first method, lanthanum nitrate, sodium aluminate, and magnesium nitrate are co-precipitated with sodium hydroxide from an aqueous solution, the precipitate is aged for 10-60 minutes at a pH of about 9.5 and 20-65° C., and then filtered, washed, dried, and calcined at a temperature of 450-732° C.

The second method differs from the first method in that that the lanthanum nitrate and the sodium aluminate are co-precipitated and aged before the magnesium nitrate and the sodium hydroxide are added.

The object of the present invention is to provide a process for the preparation of an oxidic catalyst composition with improved metal trap performance.

The invention relates to a process for the preparation of an oxidic catalyst composition consisting of one or more trivalent metals, one or more divalent metals and—calculated as oxide and based on the total composition—more than 18 wt % of one or more compounds selected from the group consisting of rare earth metal compounds, phosphorus compounds, and transition metal compounds, which process comprises the following steps:
a) preparing a precursor mixture consisting of (i) a compound 1 being one or more trivalent metal compounds, (ii) a compound 2 being one or more divalent metal compounds, (iii) a compound 3 which is different from compounds 1 and 2 and is one or more compounds selected from the group consisting of rare earth metal compounds, phosphorus compounds, and transition metal compounds, and (iv) optionally water, which precursor mixture is not a solution,
b) if the precursor mixture contains water, optionally changing the pH of the slurry,
c) optionally aging the precursor mixture,
d) drying the precursor mixture when this mixture contains water and/or aging step c) is performed, and
e) calcining the resulting product.

Apart from an improved metal trap performance, the process according to the invention also provides compositions which are suitable as FCC additives for the production of fuels with a reduced sulfur and nitrogen content.

An additional advantage of the process according to the invention is that it does not require the use of sodium-containing compounds such as NaOH and sodium aluminate. The presence of sodium is known to be undesired in fluid catalytic cracking processes. Because the process according to the present invention does not require the use of sodium-containing compounds, the resulting product does not require a sodium removal (i.e. washing) step prior to its use in fluid catalytic cracking.

That the oxidic catalyst composition “consists of” one ore more trivalent metals, one or more divalent metals, and more than 18 wt % of one or more compounds selected from the group consisting of rare earth metal compounds, phosphorus compounds, and transition metal compounds means that the oxidic catalyst composition does not contain any other materials in more than insignificant trace amounts.

For instance, the oxidic catalyst composition does not contain silica or silicon-containing compounds, because silicon has a negative influence on the metal trap performance of the oxidic catalyst compositions.

### Step a)

The first step of the process involves the preparation of a precursor mixture consisting of one or more trivalent metal compounds (compound 1), one or more divalent metal compounds (compound 2), one or more compounds selected from the group consisting of rare earth metal compounds, phosphorus compounds, and transition metal compounds (compound 3), and (iv) optionally water.

That the precursor mixture “consists of” these compounds means that it does not contain any other compounds, except for insignificant traces.

The precursor mixture is not a solution, which means that it is either a suspension or a dry mixture of solid compounds. If water is present in said mixture—i.e. if the precursor mixture is a suspension—at least one of the compounds 1 to 3 must be water-insoluble. If the precursor mixture is a dry mixture, water-soluble compounds may be used.

The precursor mixture can be prepared in various ways. Compounds 1, 2, and 3 can be mixed as dry powders or in (aqueous) suspension, thereby forming a suspension, a sol, or a gel. Compound 3 can also be added to the precursor mixture in the form of a compound 1 and/or a compound 2 that has been doped with compound 3.

The weight percentage of compound 1 in the precursor mixture preferably is 10 to 60 wt %, more preferably 20 to 40 wt %, and most preferably 25 to 35 wt %, calculated as oxides, and based on dry solids weight.

The weight percentage of compound 2 in the precursor mixture preferably is 10 to 60 wt %, more preferably 20 to 40 wt %, and most preferably 25 to 35 wt %, calculated as oxides, and based on dry solids weight.

The weight percentage of compound 3 in the precursor mixture is at least 18 wt %, preferably 18 to 60 wt %, more preferably 20 to 40 wt %, and most preferably 25 to 35 wt %, calculated as oxides, and based on dry solids weight.

The precursor mixture may be milled, either as dry powders or in suspension. Alternatively, or in addition to milling of the precursor mixture, the compounds 1, 2, and 3 can be milled individually before forming the precursor mixture. Equipment that can be used for milling includes ball mills, high-shear mixers, colloid mixers, kneaders, electrical transducers that can introduce ultrasound waves into a suspension, and combinations thereof.

### Compound 1

Suitable trivalent metals include aluminium, gallium, indium, iron, chromium, vanadium, cobalt, manganese, niobium, lanthanum, and combinations thereof. Aluminium is the preferred trivalent metal.

Aluminium compounds include aluminium alkoxide, aluminium oxides and hydroxides such as transition alumina, aluminium trihydrate (gibbsite, bayerite) and its thermally treated forms (including flash-calcined alumina), alumina sols, amorphous alumina, (pseudo)boehmite, aluminium carbonate, aluminium bicarbonate, and aluminium hydroxycarbonate. With the preparation method according to the invention it is also possible to use coarser grades of aluminium trihydrate such as BOC (Bauxite Ore Concentrate) or bauxite.

Aluminium salts, such as aluminium nitrate, chloride, or sulfate may also be used, but only if the precursor mixture does not contain water, or, if it does, when compounds 2 and/or 3 are water-insoluble. However, it is preferred not to use aluminium salts, because they introduce anions into the resulting composition, which may be undesirable.

Iron compounds include iron ores such as goethite (FeOOH), bernalite, feroxyhyte, ferrihydrite, lepidocrocite, limonite, maghemite, magnetite, hematite, and wustite, and synthetic iron products such as synthetic iron oxides and hydroxides, iron carbonate, iron bicarbonate, and iron hydroxycarbonate.

Iron salts, such as iron nitrate, chloride, or sulfate may also be used, but only if the precursor mixture does not contain water, or, if it does, when compounds 2 and/or 3 are water-insoluble. However, it is preferred not to use iron salts, because they introduce anions into the resulting composition, which may be undesirable.

Suitable gallium, indium, iron, chromium, vanadium, cobalt, cerium, niobium, lanthanum, and manganese compounds include their respective oxides, hydroxides, carbonates, bicarbonates, and hydroxycarbonates.

Water-soluble salts of these compounds may also be used, but only if the precursor mixture does not contain water, or, if it does, when compounds 2 and/or 3 are water-insoluble. However, it is preferred not to use these salts, because they introduce anions into the resulting composition, which may be undesirable.

Also mixtures of the above-mentioned trivalent metal compounds can be used, or additive-containing trivalent metal compounds, such as trivalent metal compounds doped with compound 3. Such additive-containing metal compounds are prepared by treatment of a trivalent metal compound in the presence of an additive (e.g. compound 3). Examples of additive-containing trivalent metal compounds are additive-containing quasi-crystalline boehmite according to WO 01/12551 and WO 01/12553 and additive-containing micro-crystalline boehmite according to WO 01/12552.

### Compound 2

Suitable divalent metals include magnesium, zinc, nickel, copper, iron, cobalt, manganese, calcium, barium, strontium, and combinations thereof.

Alkaline earth metals are the preferred divalent metals, with magnesium being the most preferred.

Suitable magnesium compounds are oxides or hydroxides such as MgO and Mg(OH)₂, hydromagnesite, magnesium carbonate, magnesium hydroxy carbonate, and magnesium bicarbonate.

Suitable zinc, nickel, copper, iron, cobalt, manganese, calcium, and barium compounds are the respective oxides, hydroxides, carbonates, bicarbonates, and hydroxycarbonates.

Divalent metal salts, such as nitrates, chlorides, or sulfates may also be used, but only if the precursor mixture does not contain water, or, if it does, when compounds 1 and/or 3 are water-insoluble. However, it is preferred not to use divalent metal salts, because they introduce anions into the resulting composition, which may be undesirable.

Also mixtures of the above-mentioned divalent metal compounds can be used, or additive-containing divalent metal compounds, e.g. divalent metal compounds doped with compound 3. Such additive-containing metal compounds are prepared by treatment of a divalent metal compound with a suitable additive (e.g. compound 3). An example of an additive-containing divalent metal compound is additive-containing brucite.

### Compound 3

Suitable rare earth metals include Ce, La, and mixtures thereof. Especially a mixture of Ce and La is preferred. These metals are preferably present in the precursor mixture in the form of their nitrates, chlorides, sulfates, oxides, hydroxides, etc. Also bastnaesite can be used as a suitable mixture of rare earth metals.

Lanthanum is a preferred rare earth metal, especially when the oxidic catalyst composition is to be used as a metal trap in FCC. Especially a mixture of Ce and La is preferred.

Suitable transition metals include Cu, Zn, Zr, Ti, Ni, Co, Fe, Mn, Cr, Mo, W, V, Rh, Ru, Pt, and mixtures thereof. These metals are preferably present in the precursor mixture in the form of their nitrates, chlorides, sulfates, oxides, hydroxides, carbonates, bicarbonates, and hydroxycarbonates, etc.

Zn and Fe, alone or in combination with other metals such as Ce, V, W, and Mo, are preferred transition metals.

Suitable phosphorus compounds include phosphoric acid and its salts such as ammonium dihydrogen phosphate and diammonium hydrogen phosphate, ammonium hypophosphate, ammonium orthophosphate, ammonium dihydrogen orthophosphate, ammonium hydrogen orthophosphate, triammonium phosphate, sodium pyrophosphate, phosphines, and phosphites. Suitable phosphorus-containing compounds also include derivatives of groups represented by PX₃, RPX₂, R₂PX, R₁P, R₃P═O, RPO₂, RPO(OX)₂, PO(OX)₃, R2P(O)OX, RP(OX)₂, ROP(OX)₂, and (RO)₂POP(OR)₂, wherein R is an alkyl or phenyl radical and X is hydrogen, R or halide.

The advantage of using organic phosphates is that the organic group may increase the porosity of the final product after calcining.

In the composition resulting from the process of the present invention, the additive is generally present as oxide.

### Step b)

If so desired, the pH of the precursor mixture—provided that it contains water—may be adjusted, preferably to a pH in the range 4 to 11.

This pH may be adjusted by any acid or base. Suitable acids include nitric acid, hydrochloric acid, sulfuric acid, acetic acid, oxalic acid, and formic acid. Suitable bases include sodium hydroxide, sodium (bi)carbonate, potassium hydroxide, potassium (bi)carbonate, and ammonium hydroxide. Ammonium hydroxide is the preferred base, because it does not introduce alkali metals into the composition.

### Step c)

The precursor mixture is optionally aged. Aging is done by treating the mixture in aqueous suspension at temperatures which are preferably in the range 20-200° C., more preferably 50-160° C., and autogeneous pressure. Aging is preferably conducted from 0.5-48 hours, more preferably 0.5-24 hours, most preferably 1-6 hours.

During aging, an anionic clay may be formed. Anionic clays—also called hydrotalcite-like materials or layered double hydroxides—are materials having a crystal structure consisting of positively charged layers built up of specific combinations of divalent and trivalent metal hydroxides between which there are anions and water molecules, according to the formula

[Mₘ²⁺Mₙ³⁺(OH)₂ₘ₊₂ₙ.]X_{n/z}^{z-}.bH₂O

wherein M²⁺ is a divalent metal, M³⁺ is a trivalent metal, and X is an anion with valency z. m and n have a value such that m/n=1 to 10, preferably 1 to 6, more preferably 2 to 4, and most preferably close to 3, and b has a value in the range of from 0 to 10, generally a value of 2 to 6 and often a value of about 4.

Hydrotalcite is an example of a naturally occurring anionic clay wherein Mg is the divalent metal, Al is the trivalent metal, and carbonate is the predominant anion present. Meixnerite is an anionic clay wherein Mg is the divalent metal, Al is the trivalent metal, and hydroxyl is the predominant anion present.

However, in a preferred embodiment, the precursor mixture is aged under such conditions that anionic clay formation is prevented. Aging conditions which influence the rate of anionic clay formation are the temperature (the higher, the faster the reaction), the pH (the higher, the faster the reaction), the identity and particle size of compounds 1 and 2 (larger particles react slower than smaller ones), and the presence of additives that inhibit anionic clay formation (e.g. vanadium, sulfate).

If the formation of anionic clay is prevented, calcination (step e) results in the formation of compositions comprising individual, discrete oxide entities of divalent metal oxide and trivalent metal oxide. In the case of Mg as the divalent and Al as the trivalent metal, this results in the formation of both acidic (Al₂O₃) and basic (MgO) sites being accessible to molecules to be adsorbed or to be converted in catalytic reactions.

Consequently, this enables the entrapment of both acidic compounds (e.g. S-heterocycles, SOₓ, V-containing compounds) and basic compounds (e.g. N-heterocycles, Ni-containing compounds).

The formation of anionic clay during aging can be prevented by aging for a short time period, i.e. a time period which, given the specific aging conditions, does not result in anionic clay formation.

Aging conditions which influence the rate of anionic clay formation are the temperature (the higher, the faster the reaction), the pH (the higher, the faster the reaction), the type and particle size of compounds 1 and 2 (larger particles react slower than smaller ones), and the presence of additives that inhibit anionic clay formation (e.g. vanadium, sulfate)

### Step c)

A water-containing and/or aged precursor mixture must be dried to the extent that the material becomes suitable for calcination. Drying can be performed by any method, such as spray-drying, flash-drying, flash-calcining, and air drying. It is self-evident that a dry precursor mixture which was not aged does not require a drying step.

### Step d)

The dry product is calcined at a temperature in the range of 200-800° C., more preferably 300-700° C., and most preferably 350-600° C. Calcination is conducted for 0.25-25 hours, preferably 1-8 hours, and most preferably 2-6 hours. All commercial types of calciners can be used, such as fixed bed or rotating calciners.

Calcination can be performed in various atmospheres, e.g, in air, oxygen, inert atmosphere (e.g. N₂), steam, or mixtures thereof.

Preferably, the calcination conditions are chosen such that spinel formation is prevented, as spinel is not very active as metal trap.

### Use of the Oxidic Catalyst Composition

The oxidic catalyst composition obtainable from the process according to the invention can suitably be used in or as a catalyst or catalyst additive in a hydrocarbon conversion, purification, or synthesis process, particularly in the oil refining industry and Fischer-Tropsch processes. Examples of processes where these compositions can suitably be used are catalytic cracking, hydrogenation, dehydrogenation, hydrocracking, hydroprocessing (hydrodenitrogenation, hydrodesulfurisation, hydrodemetallisation), polymerisation, steam reforming, base-catalysed reactions, gas-to-liquid conversions (e.g. Fischer-Tropsch), and the reduction of SOx and NOx emissions.

In particular, the oxidic catalyst composition is very suitable for use in FCC processes for the reduction of SOₓ and NOₓ emissions, reduction of the sulfur and the nitrogen content of fuels like gasoline and diesel, and for the entrapment of metals like V and Ni.

Preferred oxidic catalyst compositions for reduction of the sulfur and the nitrogen content of fuels are compositions comprising aluminium as the trivalent metal, magnesium as the divalent metal, and at least 18 wt % of zinc or a combination of zinc and cerium, tungsten, vanadium or molybdenum (calculated as oxides).

Preferred oxidic catalyst compositions for use as a metal trap are compositions comprising aluminium as the trivalent metal, magnesium as the divalent metal, and at least 18 wt % of lanthanum (calculated as oxides).

The oxidic catalyst composition obtainable from the process according to the invention can be added to the FCC unit as such, or in a composition containing conventional FCC catalyst ingredients such as matrix or filler materials (e.g. clay such as kaolin, titanium oxide, zirconia, alumina, silica, silica-alumina, bentonite, etc.) and molecular sieve material (e.g. zeolite Y, ZSM-5, etc. etera).

### FIGURE

FIG. 1 shows the sulfur content of the total liquid product (TLP) as a function of the conversion using the compositions of Examples 22-26 and a commercial equilibrium catalyst.

### EXAMPLES

### Example 1

A stirred reactor vessel of 600 millilitres volume was filled with 113.54 grams of water. To the water 28.48 grams Mg₅(CO₃)₄(OH)₂.5H₂O (Merck) were added as a solid. To this slurry 11.86 grams of aluminium trihydrate (ATH) (The Mill) were added. This yielded a 13 wt % oxides-containing slurry with a molar MgO to Al₂O₃ ratio of 4. After 5 minutes, 23.28 grams of a La(NO₃)₃.5H₂O-solution containing the equivalent of 5 grams La₂O₃ were added to the stirred slurry. After being homogenised, the slurry was dried in a vacuum stove at 40° C. for 4 days.

The resulting oxidic catalyst composition comprised 20 wt % of La (as La₂O₃).

### Example 2

A stirred reactor vessel of 600 millilitres volume was filled with 113.54 grams of water. To the water 28.48 grams Mg₅(CO₃)₄(OH)₂.5H₂O (Merck) were added as a solid. To this slurry 11.86 grams of aluminium trihydrate (ATH) (The Mill) were added. After 5 minutes, chromium nitrate and lanthanum nitrate were added to the stirred slurry. The Al:Cr ratio in the slurry was 3 and the La₂O₃ content (based on dry solids and calculated as oxides) was 20 wt %.

After being homogenised, the slurry was dried in a vacuum stove at 40° C. for 4 days. The XRD pattern of the dried (intermediate) product did not show the presence of anionic clay. The intermediate product was calcined for 4 hours at 500° C. in static air.

### Example 3

14.83 g La(NO₃)₃.5H₂O were dissolved in 50 ml distilled water. To this solution 29.88 g brucite and 4.0 g gibbsite were added while stirring. The mixture was then dried in a vacuum oven at 60° C. for c. 4 hrs. The sample was calcined at 500° C. for 4 hrs.

The resulting composition comprised 20 wt % La (as La₂O₃).

### Example 4

5.53 g La(NO₃)₃.5H₂O were dissolved in 50 ml distilled water. To this solution 13.88 g Mg₅(CO₃)₄(OH)₂.5H₂O (Merck) and 1.10 g gibbsite were added while stirring. A few drops of concentrated nitric acid were added to adjust the pH to 7. The mixture was then dried in a vacuum oven at 60° C. for c. 4 hrs. The resulting material was then calcined at 500° C. for 4 hrs.

The resulting composition comprised 25 wt % La (as La₂O₃).

### Example 5

A slurry with a solids content of 20 wt % was prepared by dispersing gibbsite and calcium carbonate in water. The Ca/Al molar ratio was 3. To this slurry a solution of lanthanum nitrate was added, such that the La₂O₃ content of the final composition was 20 wt %. The mixture was then dried in a vacuum oven at 60° C. for c. 4 hrs and the resulting material was calcined at 500° C. for 4 hrs

### Example 6

11.27 g La(NO₃)₃.5H₂O and 27.43 g Ba(NO₃)₂ were dissolved in 50 ml distilled water. To this 2.76 g gibbsite were added while stirring. A few drops of ammonium hydroxide were added to adjust the pH to 7. The mixture was dried in a vacuum oven at 60° C. for c. 4 hrs. The resulting material was calcined at 500° C. for 4 hrs.

The resulting composition comprised 20 wt % La (as La₂O₃).

### Example 7

15.05 g Ba(NO₃)₂, 2.46 g TiO₂, and 1.50 g gibbsite were added to 50 ml distilled water and the mixture was stirred. A few drops of ammonium hydroxide were added to adjust the pH to c. 7. The mixture was dried in a vacuum oven at 60° C. for c. 4 hrs. The sample was calcined at 500° C. for 4 hrs.

The resulting composition comprised 20 wt % Ti (as TiO₂).

### Example 8

A slurry with a solids content of 20 wt % was prepared by dispersing gibbsite and calcium nitrate in water. The Ca/Al molar ratio was 3. To this slurry a suspension of titanium oxide was added, such that the TiO₂ content, based on dry solids weight, was 20 wt %. The resulting mixture was dried in a vacuum oven at 60° C. for c. 4 hrs and the dried material was calcined at 500° C. for 4 hrs.

### Example 9

15.08 g Ba(NO₃)₂, 2.45 g ZrO₂, and 1.53 g gibbsite were added to 50 ml distilled water and the mixture was stirred. A few drops of ammonium hydroxide were added to adjust the pH to c. 7. The mixture was dried in a vacuum oven at 60° C. for c. 4 hrs. The resulting material was calcined at 500° C. for 4 hrs.

The ZrO₂-content of the resulting composition was 20 wt %.

### Example 10

A slurry with a solids content of 20 wt % was prepared by dispersing gibbsite and calcium nitrate in water. The Ca/Al molar ratio was 3. To this slurry a solution of zirconium oxide was added. The ZrO₂ content of the slurry, based on dry solids weight, was 20 wt %. The mixture was then dried in a vacuum oven at 60° C. for c. 4 hrs. The resulting material was calcined at 500° C. for 4 hrs.

### Example 11

15.52 g La(NO₃)₃.5H₂O was dissolved in 50 ml distilled water. To this 20.33 g Catapal® alumina and 9.68 g Mg₅(CO₃)₄(OH)₂.5H₂O were added while stirring. A few drops of ammonium hydroxide were added to adjust the pH to c. 7. The mixture was dried in a vacuum oven at 60° C. for c. 4 hrs. The resulting material was calcined at 500° C. for 4 hrs.

The La-content of the resulting composition (as La₂O₃) was 23 wt %.

### Example 12

A stirred reactor vessel of 600 millilitres volume was filled with 113.7 grams of water. To the water 28.44 grams Mg₅(CO₃)₄(OH)₂.5H₂O (Merck) were added as a solid. To this slurry 11.85 grams of aluminium trihydrate (ATH) (The Mill) were added. The pH of the slurry was 10.45.

After 5 minutes, 23.6 grams of a Ce(NO₃)₃.6H₂O-solution containing the equivalent of 5 grams CeO₂ were added to the stirred slurry. The final pH was 6.7. After being homogenised, the slurry was dried in a vacuum stove at 30° C. for 4 days. The XRD pattern of the dried (intermediate) product did not show the presence of hydrotalcite.

After this, the intermediate product was calcined for 4 hours at 500° C. in static air.

The Ce-content (as CeO₂) of the resulting compound was 20 wt %.

### Example 13

A stirred reactor vessel of 600 millilitres volume was filled with 114.8 grams of water. To the water 28.43 grams Mg₅(CO₃)₄(OH)₂.5H₂O (Merck) were added as a solid. To this slurry 11.86 grams of aluminium trihydrate (ATH) (The Mill) were added. The starting pH of the slurry was 10.45.

The slurry was heated to 80° C. and was kept at this temperature overnight. After this, 22.7 grams of a Ce(NO₃)₃.6H₂O-solution containing the equivalent of 5 grams CeO₂ were added to the stirred slurry. After being homogenised, the slurry was dried in a vacuum stove at 30° C. for 4 days. The XRD pattern of the dried (intermediate) product showed the presence of hydrotalcite, gibbsite, and magnesium hydroxy carbonate.

The intermediate product was calcined for 4 hours at 500° C. in static air.

The Ce-content (as CeO₂) of the resulting compound was 20 wt %.

### Example 14

0.67 g NH₄VO₃ and 3.35 g Ce(NO₃)₃.6H₂O were dissolved in 50 ml distilled water. To this 3.17 g gibbsite and 11.84 g Mg₅(CO₃)₄(OH)₂.5H₂O were added while stirring. The pH of the mixture was around 7. The mixture was dried in a vacuum oven at 60° C. for c. 4 hrs. The dried material was 500° C. for 4 hrs.

The resulting product contained 15 wt % Ce (as CeO₂) and 6 wt % V (as V₂O₅).

### Example 15

A stirred reactor vessel of 1 litre volume was filled with 269.5 grams of water. To the water 56.84 grams Mg₅(CO₃)₄(OH)₂.5H₂O were added as a solid. To this slurry 23.78 grams of aluminium trihydrate (The Mill) were added. The pH of the slurry was 10.4.

After stirring for 5 minutes, 70.6 grams of an iron nitrate solution containing the equivalent of 10 grams Fe₂O₃ were added to the stirred slurry. The final pH was 6.4. After being homogenised, the slurry was dried in a vacuum stove at 30° C. for 4 days. The XRD pattern of the dried (intermediate) product did not show the presence of anionic clay. After this, the intermediate product was calcined for 4 hours at 500° C. in static air.

The resulting composition contained 20 wt % Fe (as Fe₂O₃).

### Example 16

A stirred reactor vessel of 600 millilitres volume was filled with 114.7 grams of water. To the water 28.42 grams Mg₅(CO₃)₄(OH)₂.5H₂O were added as a solid. To this slurry 11.86 grams of aluminium trihydrate were added. The pH of the slurry was 10.4.

After 5 minutes, 14.58 grams of an iron nitrate solution containing the equivalent of 3 grams Fe₂O₃ were added to the stirred slurry. Subsequently, 502.58 grams of an ammonium vanadate solution containing the equivalent of 2 grams V₂O₅ were added to the stirred slurry. The final pH was 7.69. After being homogenised, the slurry was dried in a vacuum stove at 40° C. for 2 weeks. The XRD pattern of the dried (intermediate) product did not show the presence of anionic clay.

After this the intermediate product was calcined for 4 hours at 500° C. in static air.

The resulting composition contained 8 wt % V (as V₂O₅) and 12 wt % Fe (as Fe₂O₃).

### Example 17

Example 14 was repeated, except that Mg₅(CO₃)₄(OH)₂.5H₂O was replaced by CaCO₃. The Ca/Al molar ratio was 3.

### Example 18

Example 16 was repeated, except that Mg₅(CO₃)₄(OH)₂.5H₂O was replaced by CaCO₃. The Ca/Al molar ratio was 3.

### Example 19

6.72 g Ce(NO₃)₃.6H₂O and 1.74 g NH₄VO₃ were dissolved in 50 ml distilled water. To this 20.03 g barium nitrate and 2.07 g gibbsite were added while stirring. A few drops of ammonium nitrate were added to adjust the pH to c. 7. The mixture was dried in a vacuum oven at 60° C. for c. 4 hrs.

The dried material was calcined at 350° C. for 2 hrs.

The resulting composition comprised 15 wt % Ce (as CeO₂) and 8 wt % V (as V₂O₅).

### Example 20

A stirred reactor vessel of 600 millilitres volume was filled with 113.54 grams of water. To the water 28.41 grams Mg₅(CO₃)₄(OH)₂.5H₂O were added as a solid. To this slurry 11.85 grams of aluminium trihydrate were added. After 5 minutes, 17.6 grams of a copper nitrate solution containing the equivalent of 2.5 grams CuO were added to the stirred slurry. Subsequently, 20.61 grams of a manganese nitrate solution containing the equivalent of 2.5 grams MnO were added to the stirred slurry. The final pH was 4.5.

After being homogenised, the slurry was dried in a vacuum stove at 40° C. for 4 days. The XRD pattern of the dried (intermediate) product did not show the presence of anionic clay.

After this the intermediate product was calcined for 4 hours at 500° C. in static air.

The resulting product contained 10 wt % Mn (as MnO) and 10 wt % Cu (as CuO).

### Example 21

A stirred reactor vessel of 600 millilitres volume was filled with 113 grams of water. To the water 28.48 grams Mg₅(CO₃)₄(OH)₂.5H₂O were added as a solid. To this slurry 11.88 grams of aluminium trihydrate were added. After 5 minutes, 15.62 grams of a copper nitrate solution containing the equivalent of 2.5 grams CuO were added to the stirred slurry. Subsequently, 57.19 grams of a chromium nitrate solution containing the equivalent of 2.5 grams Cr₂O₃ were added. After being homogenised, the slurry was dried in a vacuum stove at 40° C. for 4 days. The XRD pattern of the dried (intermediate) product did not show the presence of anionic clay. After this the intermediate product was calcined for 4 hours at 500° C. in static air.

The resulting product contained 10 wt % Cr (as Cr₂O₃) and 10 wt % Cu (as CuO).

### Example 22

A stirred reactor vessel of 600 millilitres volume was filled with 113.54 grams of water. To the water 28.76 grams Mg₅(CO₃)₄(OH)₂.5H₂O were added as a solid. To this slurry 11.87 grams of aluminium trihydrate were added. The pH was 10.45.

After 5 minutes 29.3 grams of a zinc nitrate solution containing the equivalent of 5 grams ZnO were added to the stirred slurry. After being homogenised, the slurry was dried in a vacuum stove at 40° C. for 4 days. The XRD pattern of the dried (intermediate) product did not show the presence of anionic clay. After this the intermediate product was calcined for 4 hours at 500° C. in static air.

The resulting product contained 20 wt % Zn (as ZnO).

### Example 23

A stirred reactor vessel of 600 millilitres volume was filled with 114.6 grams of water. To the water 28.49 grams Mg₅(CO₃)₄(OH)₂.5H₂O were added as a solid. To this slurry 11.87 grams of aluminium trihydrate were added. The pH was 10.45.

After 5 minutes 21.7 grams of a zinc nitrate solution containing the equivalent of 3 grams ZnO were added to the stirred slurry. Subsequently, 13.05 grams of an ammonium tungstate solution containing the equivalent of 2 grams WO₃ were added. After being homogenised, the slurry was dried in a vacuum stove at 40° C. for 4 days. The XRD pattern of the dried (intermediate) product did not show the presence of anionic clay. After this the intermediate product was calcined for 4 hours at 500° C. in static air.

The resulting product contained 12 wt % Zn (as ZnO) and 8 wt % W (as WO₃).

### Example 24

Example 11 was repeated, expect that the lanthanum nitrate was replaced by zinc basic carbonate in such an amount as to arrive at a composition comprising 20 wt % Zn (as ZnO).

### Example 25

Example 11 was repeated, expect that the lanthanum nitrate was replaced by zinc basic carbonate and ammonium vanadate in such amount as to arrive at a composition comprising 15 wt % Zn (as ZnO) and 5 wt % V (as V₂O₅).

### Example 26

Example 25 was repeated, expect that ammonium vanadate was replaced by cerium nitrate. The resulting composition comprised 15 wt % Zn (as ZnO) and 5 wt % Ce (as CeO₂).

### Example 27

A slurry was prepared by dispersing 48.61 g Catapal® alumina in 144.9 g distilled water using a Warring Blender. To this slurry were added 16.63 g magnesium hydroxycarbonate and 8.87 g zinc hydroxycarbonate.

A solution comprising 3.95 g ammonium heptamolybdate in 29.4 g distilled water was added to the slurry. The pH of the resulting slurry was adjusted to 7.3 with nitric acid, after which it was immediately dried in a convection oven at 70° C. The dried powder was calcined at 500° C. for 4 hours.

### Example 28

A slurry was prepared by dispersing 48.61 g Catapal® alumina in 109.9 g distilled water using a Warring Blender. To this slurry were added 16.63. g magnesium hydroxycarbonate and 8.87 g zinc hydroxycarbonate.

A solution comprising 10.57 g cerrous nitrate hexahydrate in 29.4 g distilled water was added to the previously prepared slurry. Next, a solution comprising 2.70 g ammonium metavanadate was added. The pH of the resulting slurry was adjusted to 7.4 with nitric acid, after which it was immediately dried in a convection oven at 70° C. The dried powder was calcined at 500° C. for 4 hours.

### Example 29

Gibbsite powder (11.47 g), magnesium oxide powder (14.82 g), and lanthanum carbonate powder (17.42 g) were dry-milled. The resulting powder mixture was calcined at 500° C. for 4 hours.

### Example 30

A slurry was prepared by dispersing 22.94 g gibbsite in 65.0 g distilled water in a Warring Blender. To this slurry were added 29.64 g magnesium oxide and 34.27 g lanthanum carbonate. The pH of the resulting slurry was 8.9. This slurry was immediately dried in a convection oven at 70° C. The dried powder was calcined at 500° C. for 4 hours.

### Comparative Example A

Example 1 of EP-A 0 554 968 was repeated.

An acidic and a basic stream were simultaneously fed into a reactor containing 400 g of water. The reactor temperature was maintained at 40° C. with high-speed stirring. The acidic stream contained 65.4 g of MgO and 41.3 g La₂O₃, both in the form of the corresponding nitrates, in a total volume of 984 ml. The basic stream contained 65.6 g of Al₂O₃ in the form of aluminium nitrate and 32.1 g of 50 wt % NaOH solution, in a total volume of 984 ml. The streams were fed at an equivalent rate of about 40 ml/minute. At the same time, a 16 wt % NaOH solution was fed to the reactor in order to adjust the pH in the reactor to 9.5. The resulting slurry, after being aged for 60 minutes, was filtered and washed with distilled water. After overnight drying in a 120° C. oven, the material was calcined at 704° C. for 2 hours.

### Comparative Example B

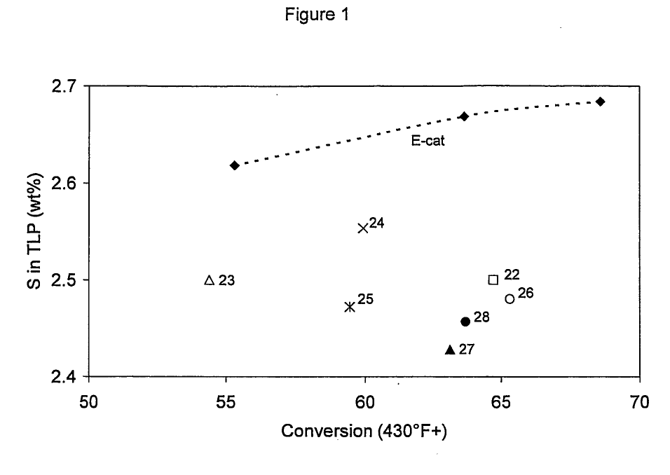

A process was conducted according to FIG. 1 of EP-A 0 554 968.

An acidic and a basic stream were simultaneously fed into a reactor containing 400 g of water. The reactor temperature was maintained at 40° C. with high-speed stirring. The acidic feedstream contained 41.3 g of La-rich rare earth oxide in the form of nitrate, in a total volume of 984 ml. The basic feedstream had a sodium aluminate solution bearing 65.6 g of Al₂O₃ along with 32.1 g of 50 wt % sodium hydroxide solution in a total volume of 984 ml. While these two streams were fed at an equivalent rate of about 40 ml/minute, the feed rate of a 16 wt % sodium hydroxide solution was adjusted so as to control the pH of the slurry in the kettle at 9.5. After aging the slurry under this condition for 60 minutes, an acidic feedstream containing 65.4 g of MgO in the form of nitrate, in a total volume of 984 ml, was added while maintaining the pH at 9.5 with a 16 wt % sodium hydroxide solution. The slurry was immediately filtered and washed using distilled water and dried overnight. After overnight drying in a 120° C. oven, the material was air calcined at 704° C. for 2 hours.

### Example 31

Samples of the calcined products obtained by several of the above Examples were tested for their suitability as vanadium trap in an FCC unit and compared with compounds known to be suitable as metal traps: hydrotalcite and barium titanate.

In this test 1 gram of a blend of 50 wt % of zeolite particles (containing 75 wt % zeolite Y in a silica matrix), 5 wt % of a composition according to one of the Examples above, 5 wt % of inert particles (80 wt % kaolin in a silica matrix), and 40 wt % of V-impregnated FCC catalyst particles were steamed in a fixed bed at 788° C. for 5 hours. The particles were all about 68 microns in diameter.

The micropore volume (MiPV) of the zeolite Y was measured before and after the test using nitrogen adsorption.

Vanadium causes the micropore volume of the zeolite Y to deteriorate. So, the better the vanadium passivating capacity of the sample, the higher the micropore volume of the zeolite that will be retained in this measurement. The micropore volume retention (percentage of MiPV left after steaming) of the zeolite in the presence of the compositions according to the different Examples is indicated in Table 1 below and is compared with that of compounds known to be suitable as metal traps: hydrotalcite and barium titanate.

TABLE 1

| Example | MiPV retention (%) |
|---|---|
| 1 | 88 |
| 3 | 88 |
| 4 | 87 |
| 11 | 79 |
| 29 | 89 |
| 30 | 92 |
| Comp. A | 75 |
| Comp. B | 56 |
| hydrotalcite | 74 |
| barium titanate | 78 |

These results show that the process according to the invention leads to better metal traps than the process of EP-A 0 554 968. The compositions according to the invention are even better metal traps than conventional metal trap materials such as hydrotalcite and barium titanate.

### Example 32

The calcined products obtained by Examples 22 through 28 were tested for their suitability as FCC additive for the production of sulfur-lean hydrocarbons. The samples were blended with a commercial equilibrium catalyst (E-cat); the blend containing 20 wt % of the desired sample and 80 wt % of E-cat.

The blends were tested in a fixed bed test unit (MST) using a regular FCC feed containing 2.9 wt % of sulfur and a cracking temperature of 550° C. The sulfur content of the total liquid product (TLP) was measured at a catalyst to oil ratio of 4. This sulfur content is plotted in FIG. 1 as a function of the conversion. The numbers indicated in this Figure indicate the relevant Example numbers.

As a reference, the sulfur content of a 100 wt % E-cat sample, measured with catalyst to oil ratios of 2.5, 3.5, and 4.5, is also displayed.

FIG. 1 shows that the compositions according to the invention are capable of producing hydrocarbons with a reduced sulfur content.

1. Process for the preparation of an oxidic catalyst composition consisting of one or more trivalent metals, one or more divalent metals and—calculated as oxide and based on the total composition—more than 18 wt % of one or more compounds selected from the group consisting of rare earth metal compounds, phosphorus compounds, and transition metal compounds, which process comprises the following steps:
a) preparing a precursor mixture consisting of (i) a compound 1 being one or more trivalent metal compounds, (ii) a compound 2 being one or more divalent metal compounds, (iii) a compound 3 which is different from compounds 1 and 2 and is one or more compounds selected from the group consisting of rare earth metal compounds, phosphorus compounds, and transition metal compounds, and (iv) optionally water, which precursor mixture is not a solution,
b) if the precursor mixture contains water, optionally changing the pH of the slurry,
c) optionally aging the precursor mixture,
d) drying the precursor mixture when this mixture contains water and/or aging step c) is performed, and
e) calcining the resulting product.

2. A process according to claim 1 wherein the precursor mixture of step a) is sodium-free and the optional pH change in step b) is performed by the addition of ammonium hydroxide.

3. A process according to claim 1 wherein the precipitate is aged in step c) without anionic clay being formed.

4. A process according to claim 1 wherein the divalent metal of compound 2 is selected from the group consisting of Mg, Ca, Ba, Zn, Ni, Cu, Co, Fe, Mn, and mixtures thereof.

5. A process according to claim 4 wherein the divalent metal is magnesium and compound 2 is selected from the group consisting of magnesium magnesium oxide, magnesium hydroxide, magnesium carbonate, magnesium hydroxyl carbonate, and mixtures thereof.

6. A process according to claim 1 wherein the trivalent metal of compound 1 is selected from the group consisting of Al, Ga, Fe, Cr, and mixtures thereof.

7. A process according to claim 6 wherein the trivalent metal is Al and wherein compound 1 is selected from the group consisting of aluminium oxides, aluminium trihydrate, thermally treated aluminium trihydrate, gel alumina, boehmite, and mixtures thereof.

8 A process according to claim 6 wherein the trivalent metal is Fe and wherein compound 1 is selected from the group consisting of iron oxides and iron hydroxides.

9. A process according to claim 1 wherein compound 3 is a compound comprising a metal selected from the group consisting of Cu, Zn, Zr, Ti, Ni, Co, Fe, Mn, Cr, Mo, W, V, Ce, La, and mixtures thereof.

10. A process according to claim 1 wherein compound 3 is introduced into the precursor mixture by using a compound 1 that has been doped with compound 3 and/or a compound 2 that has been doped with compound 3.

11. A process according to claim 1 wherein compound 3 is present in the composition in a total amount of 18 to 60 wt %, calculated as oxide and based on the total composition.

12. Oxidic catalyst composition obtainable by the process according to claim 1.

13. Catalyst particle comprising the oxidic catalyst composition according to claim 12, a matrix and/or filler, and a molecular sieve.

14. Use of the oxidic catalyst composition of claim 12 in a fluid catalytic cracking process.

15. Use of the catalyst particle of claim 13 in a fluid catalytic cracking process.
